(19) United States
(12) Patent Application Publication
(10) Pub. No.: US 2009/0001802 A1
(43) Pub. Date: Jan. 1, 2009

(54) Extraction of Actinides From Mixtures and Ores Using Dendritic Macromolecules

(76) Inventors: Mamadou S. Diallo, Pasadena, CA (US); Jean Frechet, Oakland, CA (US); Emine Boz, Los Angeles, CA (US)

Correspondence Address: THELEN LLP, P. O. BOX 640640, SAN JOSE, CA, 95164-0640, US

(21) Appl. No.: 12/124,952

(22) Filed: May 21, 2008

Related U.S. Application Data
(60) Provisional application No. 60/931,306, filed on May 21, 2007.

(51) Int. Cl. E21B 43/28; C22B 60/02; C08G 73/02

(52) U.S. Cl. 299/5; 423/7; 528/246; 528/372; 528/422

(57) ABSTRACT

A novel class of dendritic macromolecules is provided having a core, a hyperbranched structure, and a plurality of units satisfying the formula —NR²(C═O)R¹, in which R¹ is not a continuation of the hyperbranched structure. Methods of preparing these dendritic macromolecules are also provided, as well as methods of using dendritic macromolecules, including those described above, in separation processes or as part of in situ leach mining processes. A class of facilities for in situ leach mining is also provided.

### CROSS-REFERENCE TO RELATED APPLICATIONS

This application claims the benefit of priority from U.S. Provisional Application No. 60/931,306, filed May 21, 2007, entitled “In-Situ Leach Mining with Dendrimer-Assisted Filtration.”

### GOVERNMENT RIGHTS

The United States Government may have certain rights in this application pursuant to Grant CBET # 0506951 awarded by the National Science Foundation.

### TECHNICAL FIELD

This subject matter relates generally to methods, apparatuses and materials for using dendritic macromolecules to aid in the extraction and recovery of actinides from ores, spent nuclear fuel rods and mixtures such as, without limitation, in-situ leach (ISL) mining solutions, contaminated water and industrial waste streams from phosphate mines and phosphoric acid processing plants.

### BACKGROUND

The need to selectively extract or separate metallic elements from mixtures of other elements arises in a number of contexts. A particular need is the extraction of actinides from mixtures and ores. In the production, processing and burning of nuclear fuels, a mixture of uranium, plutonium and thorium, transuranic elements (TRU), and other fission products is often produced. This mixture needs to be processed to extract the actinides with fuel values (uranium, thorium and plutonium) while the TRU with no fuel values (e.g., curium and americium) need to be extracted and disposed. Thus, chemical separation processes are key unit operations of the nuclear fuel cycle. Solvent extraction, ion exchange extraction, and sorption are the most widely used separation technologies in the production, reprocessing and disposal of actinide-based fuels. During the last 50 years, the PUREX solvent extraction process has become the standard technology for recovering uranium (U) and plutonium (Pu) from spent nuclear fuel rods (Paiva and Malik (2004), J. Rad. Nucl. Chem. 261:485). In a typical PUREX plant, the spent nuclear fuel rods are first dissolved in a concentrated nitric acid solution, producing an acidic mixture of UO₂(NO₃)₂, Pu(NO₃)₄, and complexes of nitrate with other fission products. This mixture is then extracted with a counter-current mixture of kerosene containing approximately 30% tributyl phosphate (TBP). Because U(VI) and Pu(IV) form strong complexes with TBP, they partition into the organic phase as the complexes [UO₂(NO₃)₂(TBP)₂] and [Pu(NO₃)₄ (TBP)₂]. Following solvent extraction, a reducing agent (e.g., Fe(II) sulfamate or hydrazine) is added to the organic phase. This causes the reduction of Pu(IV) to Pu(III) and subsequent migration of the Pu(III) species into the aqueous phase due to their lack of affinity for TBP. The Pu(III) species are then re-oxidized to Pu(IV) and thermally decomposed to PuO₂ following precipitation. Conversely, the uranium nitrate complexes are extracted back into an aqueous phase; crystallized and thermally decomposed to UO₃ followed by hydrogen reduction to form UO₂.

While sorption has been primarily employed in nuclear waste management to recover uranium, plutonium, and other fission products from aqueous waste streams, ion exchange extraction is widely used in the nuclear fuel cycle (Navratil and Wei (2001), Nukleonika 46: 75). In nuclear waste management, ion exchange extraction is employed to remove dissolved uranium, plutonium, transuranic elements, and other fission products from aqueous solutions and high level radioactive wastes (HLW). Anion exchange from nitric acid is also used to extract plutonium from spent nuclear fuel.

Solvent extraction and ion exchange extraction have major drawbacks as methods for separating metals, including poor selectivity, low efficiency and environmental impact. Because TBP is not a selective ligand for actinides, a high concentration of HNO₃ (3.0-4.0 M) in the aqueous phase is needed in the PUREX process to enhance the partitioning of U(VI) and Pu(IV) as nitrate-TBP complexes into the organic phase. The subsequent separation of uranium from plutonium also requires the addition of chemicals (e.g., hydrazine) to the organic phase to promote the reduction of Pu(IV) to Pu(III) and subsequent migration of the plutonium species into the aqueous phase. Solvent extraction also generates a significant amount of waste containing transuranic elements and other fission products that need to be disposed. The separation of trivalent actinides with long half-lives, like americium(III), from trivalent lanthanide fission products and their subsequent transmutation into shorter-lived isotopes could significantly reduce the amount of high level radioactive wastes to be stored in a nuclear disposal facility.

The selectivity of ion exchange extraction is also poor. In plutonium recovery by ion exchange extraction, a high concentration of HNO₃ (about 6.0 M) is required to promote the formation of anionic nitrate-Pu(IV) complexes with strong binding affinity toward the ion exchange resins. As a result, the background NO₃⁻ ions in the feed solution compete with the nitrate-plutonium complexes for the resin sites. The kinetics of actinide uptake and release by ion exchange resins is also slow. The self-irradiation of actinide-laden resins also greatly complicates the safe operation of ion exchange columns in actinide separation plants. Thus, there is a great need for more selective, efficient and environmentally acceptable and safer actinide separation technologies. In particular, there remains a need for high capacity, selective, recyclable and thermally stable chelating agents for actinides that can operate efficiently in complex aqueous solutions (e.g., highly acid media) under high radiation fields.

Another context in which the selective separation of actinides and other elements from mixtures is required is in mining operations. For example, in-situ leaching (ISL, also called “solution mining”), which is a mining process that involves the extraction of a valuable element (such as uranium) by injection of a leaching fluid into the ore zone of a subsurface formation, and subsequent recovery of the dissolved elements (Davis and Curtis (2007), NUREF/CR-6870 Report “Consideration of Geochemical Issues in Groundwater Restoration at Uranium In-Situ Leach Mining Facilities”). In general, the process involves drilling injection and extraction wells into an ore deposit. Explosive or hydraulic fracturing is sometimes used to create open pathways within the deposit, which a liquid can penetrate. A leaching solution (referred to as a lixiviant) is pumped into the deposit, where it makes contact with the ore. In most cases, the lixiviant is an alkaline or acid solution, with added chemicals (e.g., bicarbonate, sulfate, oxygen, or hydrogen peroxide) that aid in the extraction of the desired element. This solution leaches the element of interest as it migrates through the ore zone. The metal-laden aqueous solution is then pumped to the surface and processed in an above-ground facility to extract the desired elements. Because ISL enables the mining and recovery of the element of interest without excavation of the subsurface, it has emerged as the technology of choice for mining uranium from permeable subsurface deposits such as sandstones. Early tests of ISL mining of uranium were conducted in Wyoming at the Shirley Basin Uranium project in 1961-1963 (G. M. Mudd (2001), Environ. Geol. 41: 390). Approximately 26% of the uranium produced in the world is mined by ISL.

The formulation of the lixiviant solution is an important step in for uranium ISL mining. It determines to a large extent the feasibility, cost, environmental impact and public/regulatory acceptance of ISL mining. Because most uranium ores consist of U(IV) minerals (e.g., uraninite and pitchblende), a typical lixiviant will include:
1. An oxidizing agent that will cause the dissolution of the ores through oxidation of U(IV) to U(VI);
2. A water-soluble complexing agent (e.g., carbonate and sulfate) with (i) high binding affinity for the released U(VI) ions in solution and (ii) low sorption affinity for the gangue minerals.
   Depending on the mineralogy of the deposit and groundwater geochemistry, acid and alkaline lixiviant solutions may be used. In general, the use of acid lixiviant solutions (e.g., sulfuric acid) in ISL uranium has a greater environmental footprint. It often causes a significant increase of the concentration of dissolved ions (10-25 g/L) during mining due to greater dissolution of the gangue minerals. Thus, groundwater restoration to baseline conditions is more costly and requires an extended treatment period. Conversely, alkaline lixiviant solutions (e.g. CO₂+O₂) are more “selective” for uranium and do not cause a significant increase in dissolved ions. However, mineral precipitation at high pH can lead to the plugging of the underlying subsurface formation. Thus, there is a great need for more efficient and environmentally acceptable lixiviant solutions for uranium ISL mining.

Chemical separation processes are key unit operations of ISL mining facilities and processing plants. Where an acid or alkaline lixiviant is used for uranium mining, countercurrent extraction may be employed to strip the uranium (see U.S. Pat. No. 5,419,880). Where carbonate lixiviants are used, ion exchange extraction is typically used to separate and recover uranium from in-situ mining leaching solutions. Ion exchange extraction involves the exchange of the target species (U(VI), in the form of uranyl ion, UO₂⁺²) with the exchangeable ions of an organic polymeric resin or inorganic matrix.

As with the problem of extracting elements from nuclear reaction products, ion exchange extraction in the context of ISL mining has the problem of poor selectivity, low efficiency and adverse environmental impact. For example, CO₂ is often added upstream to a uranium-laden leaching solution to enhance the binding of U(VI) to the ion exchange resins as uranyl dicarbonate (UO₂(CO₃)₂)⁻². A high concentration (˜30 g/L) of salt (NaCl) is also required to strip the bound uranyl ion from the resins for their subsequent processing into uranium oxide (yellow cake), and the salt solution (i.e., brine) must be reclaimed or disposed of at added expense. The net result, after salt elution of the resin, is about a 300-fold increase in uranium concentration. Thus, there remains a need for rapid, efficient, environmentally acceptable and economical methods of extracting and processing uranium from ISL solutions.

Groundwater restoration is a critical component of uranium mining by ISL. In the U.S., the Nuclear Regulatory Commission (NRC) regulates the operation of ISL uranium mining facilities. The NRC requires its licensees to pay (i.e., bond) the costs of decommissioning uranium ISL mines. Significant portions of the decommissioning funds (˜40%) go to groundwater restoration (Davis and Curtis (2007), NUREF/CR-6870 Report “Consideration of Geochemical Issues in Groundwater Restoration at Uranium In-Situ Leach Mining Facilities”). The remediation and subsequent restoration of groundwater to baseline conditions at most ISR mining facilities occur in two phases. In the initial phase, groundwater is pumped [without recirculation] to flush contaminants from the mining area. This is followed by a pump-and-treat phase using reverse osmosis (RO) to remove the residual U(VI) ions and other dissolved ions. The RO treated groundwater is then injected into the subsurface formation. Although RO is very effective at removing dissolved ions, it is costly and requires high pressures (˜100 psi) and energy to operate. Moreover, RO generates significant amount of wastes (i.e., membrane concentrates) that needed to be disposed. Thus, there is a need for lower cost and environmentally acceptable groundwater remediation technologies at uranium ISR mining facilities.

Dendritic macromolecules are emerging as ideal platforms for the development of advanced materials and processes for industrial and environmental separations (Tomalia et al. (2007), Dendrimers—an Enabling Synthetic Science To Controlled Organic Nanostructures. Chapter 24, Handbook of Nanoscience, Engineering and Technology, 2nd Edition, CRC Press: Boca Raton, Fla.). Certain kinds of dendritic molecules, such as unsubstituted PAMAM, PPI and the Priostar dendrimers, can be acquired commercially from such sources as Dendritech, DSM and Dendritic Nanotechnolgies. Some other types of dendritic macromolecules have been described, such as the actinide binding phosphorous-based dendrimers disclosed by Dozol (2006) in U.S. patent application 2006/020590 A1. However, their usefulness in nuclear separations, water treatment and ISL mining has been limited to some extent because there has been limited information and research about their binding properties to actinides and lanthanides. This is particularly the case with actinides such as Uranium, where prior studies (e.g., Ottaviani (2000), Langmuir, 16:7368) have not suggested or described significant ways of using dendritic macromolecules in actinide separation processes.

### SUMMARY

The present disclosure relates to dendritic macromolecules, methods of using these macromolecules to extracting actinides from mixtures and ores, and methods and facilities for in situ leach mining. Various embodiments are possible, which are exemplified here. These examples in no way limit or otherwise affect the scope or meaning of the claims, and are presented as illustrations only.

In one embodiment, a class of dendritic macromolecules is provided comprising a core, a plurality of arms extending from the core, the arms having a hyperbranched structure, and within the hyperbranched structure, a plurality of units satisfying the following formula:

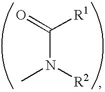

where R¹ comprises no nitrogen atoms that are simultaneously bound to two or more carbon atoms, such as, without limitation, secondary and tertiary amines or amides.

In a second embodiment, a method of preparing a dendritic macromolecule is provided that comprises the steps of mixing a hyperbranched polyethyleneimine (PEI) polymer with an anhydride and an acid chloride, under conditions sufficient to create the class of dendritic macromolecules described above.

In a third embodiment, a separation method is provided including the steps of introducing the dendritic macromolecule described above, which is bound to an actinide, into an aqueous environment at a pH level that is less than about 5, and where the concentration of an ionic salt at about 0.1 moles per liter of solution, to produce a first composition of matter comprising an unbound dendritic macromolecule and an unbound metal element, and further comprising the step of extracting the unbound dendritic macromolecule from the aqueous solution.

In a fourth embodiment, a method for in-situ leach mining is provided that includes the steps of contacting an ore with a lixiviant solution to dissolve metal ions from the ore, providing conditions whereby the dissolved metal ions bind to a dendritic macromolecule, and extracting the resulting ion-macromolecule complex, leaving a solution that is relatively purified of the ion-macromolecule complex.

In a fifth embodiment, a facility for in-situ leach mining is provided that includes a means for dissolving metal ions from an underground ore, means for binding the dissolved metal ions to a dendritic macromolecule, and a separation unit for extracting the ion-macromolecule complex.

### BRIEF DESCRIPTION OF THE DRAWINGS

The accompanying drawings, which are incorporated into and constitute a part of this specification, illustrate one or more exemplary embodiments of the inventions disclosed herein and, together with the detailed description, serve to explain the principles and exemplary implementations of these inventions. One of skill in the art will understand that the drawings are illustrative only, and that what is depicted therein may be adapted based on the text of the specification or the common knowledge within this field.

In the drawings:

FIG. 1 shows a few of the many possible dendritic macromolecules that may be used according to the present disclosure.

FIG. 2 shows the multi-chain of a dendronized polymer being stretched as branching increases.

FIG. 3 shows a dendronized polymer with nearly 1300 repeat units per molecule.

FIG. 4 shows the structure of an un-modified G4-NH₂ PAMAM Dendrimer.

FIG. 5 shows the structure of an un-modified G5-NH₂ PPI Dendrimer.

FIG. 6 shows the fluorescence spectra of aqueous U(VI) in the presence of G4-NH₂ (FIG. 6A) and G4-OH (FIG. 6B) PAMAM dendrimers at pH 2.

FIG. 7 shows the extent of binding (FIG. 7A) and fractional binding (FIG. 7B) of U(VI) in aqueous solutions of G4-NH₂ PAMAM dendrimer at various pH values.

FIG. 8 compares the extent of binding (FIG. 8A) and fractional binding (FIG. 8B) of U(VI) in aqueous solutions of PAMAM dendrimers having different functional groups.

FIG. 9 shows the effect of dendrimer generation number on the extent of binding (FIG. 9A) and fractional binding (FIG. 9B) of U(VI) in aqueous solutions of NH₂-functionalized PAMAM dendrimers.

FIG. 10 shows the effect of dendrimer backbone structure on the extent of binding (FIG. 10A) and fractional binding (FIG. 10B) of U(VI) in aqueous solutions of NH₂-functionalized PAMAM and PPI dendrimers having equal numbers of functional groups.

FIG. 11 shows the effect of nitric acid on the extent of binding (FIG. 11A) and fractional binding (FIG. 11B) of U(VI) in aqueous solutions of G4-NH₂ PAMAM dendrimer.

FIG. 12 shows the effect of phosphoric acid on the extent of binding (FIG. 12A) and fractional binding (FIG. 12B) of U(VI) in aqueous solutions of G4-NH₂ PAMAM dendrimer.

FIG. 13 shows the effect of sodium carbonate on the extent of binding (FIG. 13A) and fractional binding (FIG. 13B) of U(VI) in aqueous solutions of G4-NH₂ PAMAM dendrimer.

FIG. 14 shows the effect of sodium chloride on the extent of binding (FIG. 14A) and fractional binding (FIG. 14B) of U(VI) in aqueous solutions of G4-NH₂ PAMAM dendrimer.

FIG. 15 shows one method of separation by dendrimer filtration.

FIG. 16 shows cross-flow ultrafiltration of aqueous solutions of U(VI)+G4-NH₂ PAMAM dendrimer at pH 5.0.

FIG. 17 illustrates several example chemical modification strategies for PEI based on the conversion of amines to amido functional groups via reaction of the macromolecule with anhydrides or acid chlorides.

FIG. 18 shows the preparation of a polystyrene-cored dendronized polylysine.

FIG. 19 shows the preparation of a core crosslinked star polymers using styrene monomers substituted acrylamide monomers

FIG. 20 shows the preparation of a core crosslinked star polymers using substituted acrylamide monomers

FIG. 21 shows the extension of poly(propylene imine) or poly(lysine) dendrimers by using their chain ends to initiate a living polymerization of monomers.

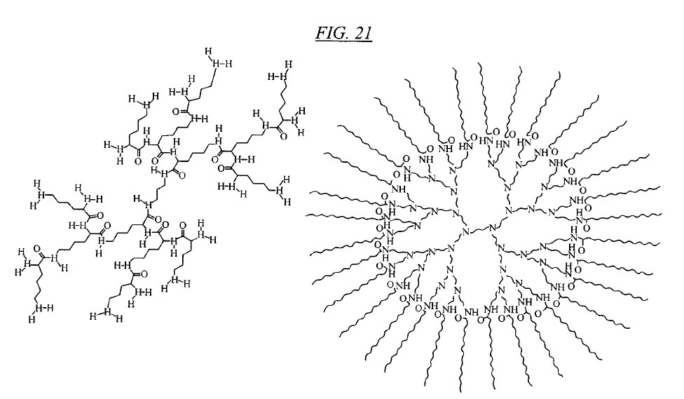

FIG. 22 shows a multisite model of U(VI) binding to PAMAM dendrimer.

FIG. 23 illustrates the process of mining by in-situ chemical leaching.

### DETAILED DESCRIPTION

Various example embodiments of the present inventions are described herein in the context of extracting actinides from mixtures and ores using dendritic macromolecules. Example embodiments are disclosed, including classes of dendritic macromolecules selective for Uranium, methods and systems for recovering Uranium from solid mixtures such as nuclear fuel rods, and systems for in situ leach mining of Uranium. Such embodiments have the advantage that they are highly selective, environmentally friendly, and efficient.

The inventions disclosed herein exploit the rich chemistry, controlled molecular architecture and unique physicochemical properties of dendritic macromolecules to provide advanced chelating agents and separation processes which may be applied, for example, to the separation of actinides and lanthanides, such as, without limitation, U(VI), Th(IV), Am(III), Eu(III), Pu(IV) and Np(V). These radionuclides are of importance in the nuclear fuel cycle and in spent nuclear fuel processing. U(VI) is also of importance in uranium mining.

Those of ordinary skill in the art will understand that the following detailed description is illustrative only and is not intended to be in any way limiting. Other embodiments of the present inventions will readily suggest themselves to such skilled persons having the benefit of this disclosure, in light of what is known in the relevant arts, such as the arts of organic and inorganic chemistry, mining, chemical engineering, environmental chemistry, nanotechnology, and other related areas. Reference will now be made in detail to exemplary implementations of the present inventions as illustrated in the accompanying drawings.

In the interest of clarity, not all of the routine features of the exemplary implementations described herein are shown and described. It will of course, be appreciated that in the development of any such actual implementation, numerous implementation-specific decisions must be made in order to achieve the specific goals of the developer, such as compliance with application and business-related constraints, and that these specific goals will vary from one implementation to another and from one developer to another. Moreover, it will be appreciated that such a developmental effort might be complex and time-consuming, but would nevertheless be a routine undertaking of engineering for those of ordinary skill in the art having the benefit of this disclosure.

Throughout the present disclosure, relevant terms are to be understood consistently with their typical meanings established in the relevant art. However, without limiting the scope of the present disclosure, further clarifications and descriptions are provided for relevant terms and concepts as set forth below:

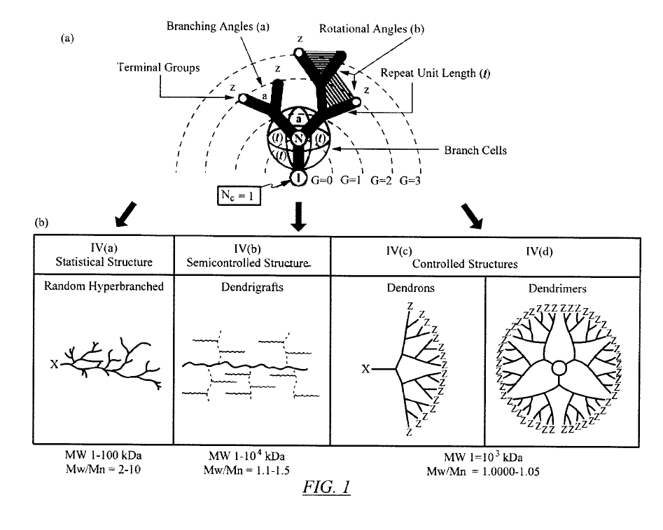

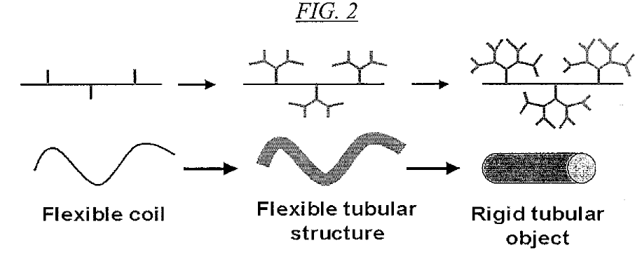

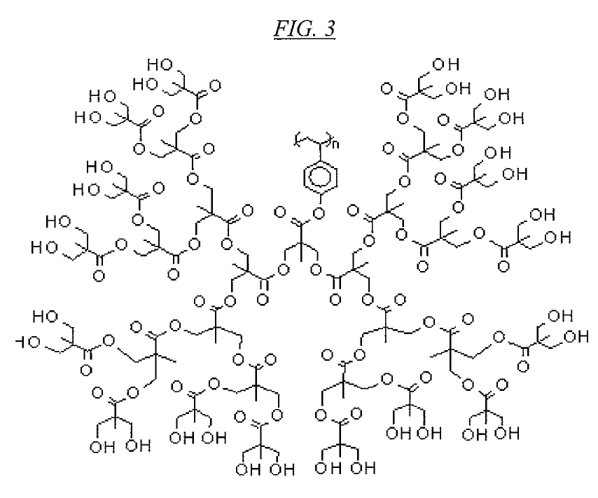

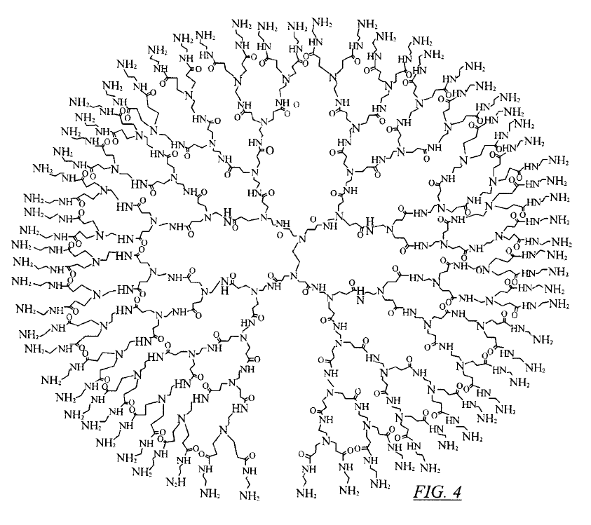

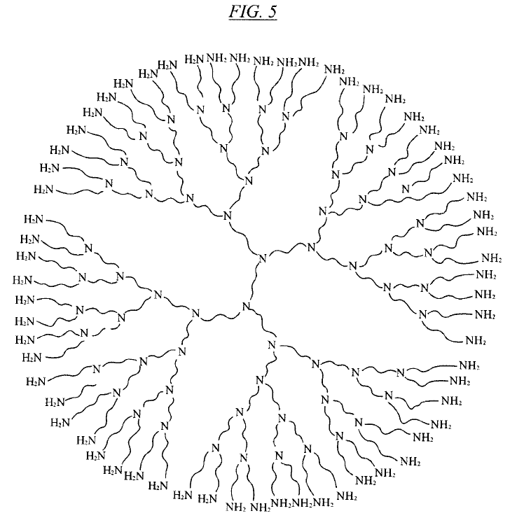

The terms dendrimer and dendritic macromolecule are interchangeable, and refer to macromolecules that may have three covalently bonded components: a core, interior branch cells and terminal branch cells. Dendritic macromolecules may include globular dendrimers, dendrons, hyperbranched polymers, dendrigraft polymers, tecto-dendrimers, core-shell (tecto) dendrimers, hybrid linear-dendritic copolymers, dendronized polymers, dendrimer-based supramolecular assemblies and dendrimer-functionalized solid particles. FIG. 1, FIG. 2, FIG. 3, FIG. 4, and FIG. 5 show some examples of different types of dendritic macromolecules.

The term dendritic agent refers to a chemical composition comprising dendritic macromolecules. The dendritic agent may, as an illustrative example, comprise a single dendritic macromolecule with a single functionality, a single dendritic macromolecule with multiple functionalities, a mixture of dendritic macromolecules, dendritic macromolecules that have been cross-linked to other dendritic macromolecules, dendritic macromolecules that have been covalently linked to other macromolecules or dendritic macromolecules that have been attached to a solid support or substrate. Referring to something as a dendritic agent does not limit what materials or substances, other than the dendritic macromolecule, that can be part of the agent, or its physical form. For example, a dendritic agent may also include buffers, salts, stabilizers or inert ingredients, and may be provided in a number of forms, including but not limited to solids, solutions, suspensions, gels, semi-liquids, and slurries. As will be recognized by one of skill in the art, there are a variety of different dendritic agent compositions that would be suitable for the system and would therefore fall within the scope of the present invention.

The term measurable, in the context of this disclosure, means that one of skill in the art, using presently available technology, can unambiguously detect and identify the presence of the item or phenomenon to be measured.

The term filter as used herein has its normal and customary meaning in the field of engineering and chemistry, and includes, among other things, an entity, often a physical barrier, that retains some molecules or compounds while allowing others to pass through. In some cases, the selection of what passes through the filter is based on size; for example, a filter retains larger compounds and molecules while allowing smaller ones to pass through. An example of a simple size-based filter is a porous membrane. Membrane-bases systems may be suitable for use in separating bound or unbound dendritic macromolecules from an aqueous solution containing other substances, as a membrane may be used that has a smaller pore size than the dendritic macromolecule, so that the dendritic macromolecule, including anything bound to it, is retained by the membrane, while the remaining substances in the aqueous solution, such as and including the water, pass through the membrane as a filtrate.

Dendritic macromolecules are a versatile classes of nanomaterials, and among their uses, they can be used to selectively bind to, or react with, a particular element, ion, or molecule of choice. Dendritic macromolecules are very large, yet soluble macroligands, and well defined sizes and shapes can be made, with hundreds or even thousands of complexing sites and reactive chain-ends. They can also be covalently linked to each other or to other macromolecules to form supramolecular assemblies of various size, shape and topologies. Dendrimer-metal ion complexes can also be effectively separated from aqueous solutions using membrane-based technologies such as ultrafiltration (UF) and microfiltration (MF) depending on the size of the dendrimer-metal ion complexes. Dendritic macromolecules can also be functionalized with surface groups that make them soluble in selected solvents or bind to selected surfaces.

By way of illustration, one class of dendritic macromolecules consists of a linear backbone to which a highly branched dendron is appended at each repeat unit either by single step grafting, by divergent synthesis, by direct polymerization of a dendronized monomer or through a combination of methods known in the art (for example, without limitation, see the teachings of Yoshida (2005), Macromolecules 2005, 38:334). As shown in FIG. 2, the main-chain of this type of dendritic polymer becomes stretched as branching increases, and the macromolecule becomes more rigid and shape-persistent, thus facilitating its recovery when used as a complexing medium. As a further example, the dendronized polymer shown in FIG. 3 may be prepared with nearly 1300 such repeat units per molecule. Such a molecule would have a molecular weight of almost 5 million, and nearly 45,000 terminal hydroxyl group per molecule.

Actinide-selective dendritic macromolecules can be synthesized with various functional groups containing N and O donors. Possible functional groups may include, without limitation, amino, amido, imidazole, triazole, carboxylate and sulfonate. The groups may bind to the actinides through coordination or ionic binding.

Among the many possible dendritic macromolecules that may be used according to the present disclosure, poly(amidoamine) (PAMAM) and poly(propylenimine) (PPI) dendrimers (with diamnoalkane cores and terminal NH₂ groups) are good illustrative examples. Another example is hyperbranched polyethyleneimine (PEI). This may include, without limitation, unsubstituted versions of these molecules, as well as other structurally-related molecules, many of which are known in the art. PAMAM dendrimers such as that shown in FIG. 4 possess N donors (primary and tertiary amines) and O/N amide donors arranged in regular “branched upon branched” patterns, which are displayed in geometrically progressive numbers as a function of generation level. Conversely, PPI dendrimers such as that shown in FIG. 5 have aliphatic N donors (primary and tertiary amines) linked by propyl chains. PAMAM, PPI, or PEI can also be modified by chemical reactions which modify their functional groups so that they have particular binding properties. In particular, the high density of nitrogen or oxygen ligands in these dendrimers, along with the possibility of attaching various functional groups (e.g., carboxyl among many others) to them, make PAMAM, PPI, and PEI macromolecules particularly attractive as high capacity chelating agents for metal ions. Furthermore, these molecules can serve as “models” and building blocks for developing related dendritic macromolecules for use in industrial processes. PAMAM, PPI, and PEI can be modified in many ways, through methods known in the art. Thus, with an effective PAMAM, PPI, or PEI macromolecule with the proper binding and other chemical or physical characteristics in hand, one of skill in the art can, using methods known in the art, produce a great variety of related dendritic macromolecules which are structurally-related and functionally-equivalent to the modified PAMAM, PPI, or PEI through cross-linking, interior and surface functionalization and extension such as that depicted in FIG. 3, and other methods known.

The present disclosure describes the binding properties and other characteristics of useful dendrimers as defined in the claims. Given the present disclosure, and knowing the properties and characteristics of these dendrimers, one of skill in the art will be able to apply well-established trends and well-known principles in actinide and lanthanide coordination chemistry (e.g., Cotton (2006), Lanthanide and Actinide Chemistry. John Wiley & Sons, New York) along with well-known dendrimer synthetic strategies and structural relationships (e.g., Frechet and Tomalia (2001), Dendrimers and other Dendritic Polymers (Eds) Wiley and Sons: New York), to obtain other related dendritic macromolecules which are also within the scope of the claimed inventions.

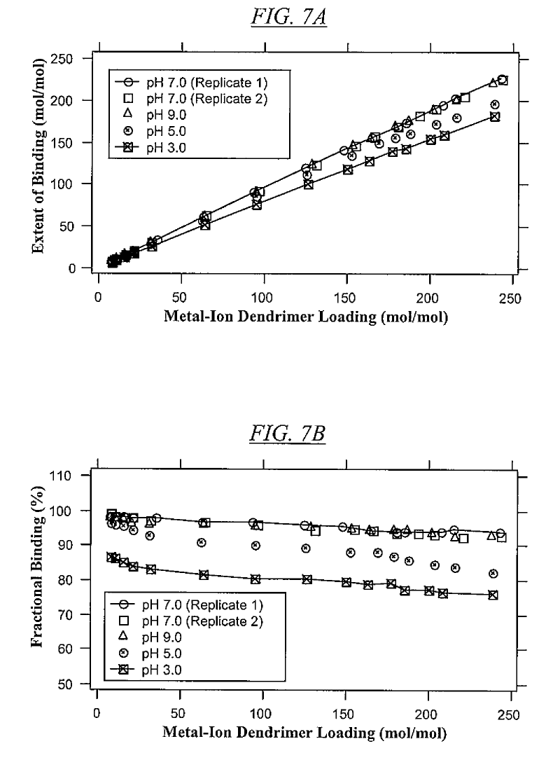

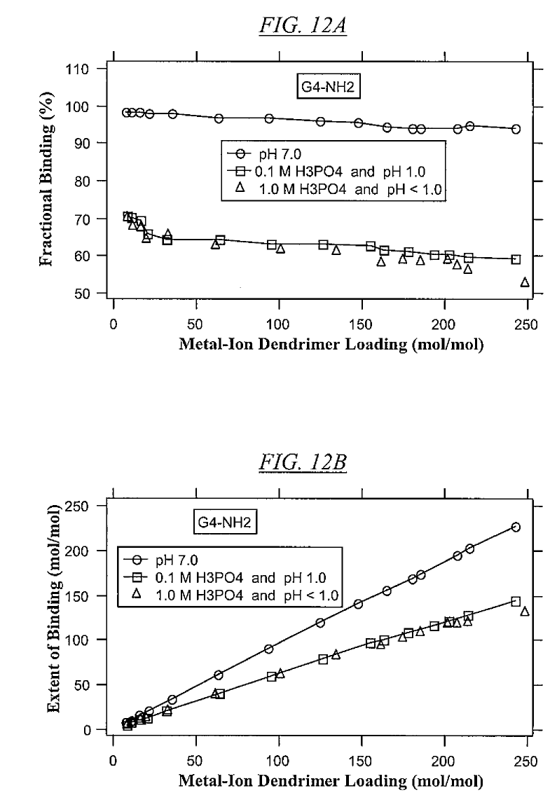

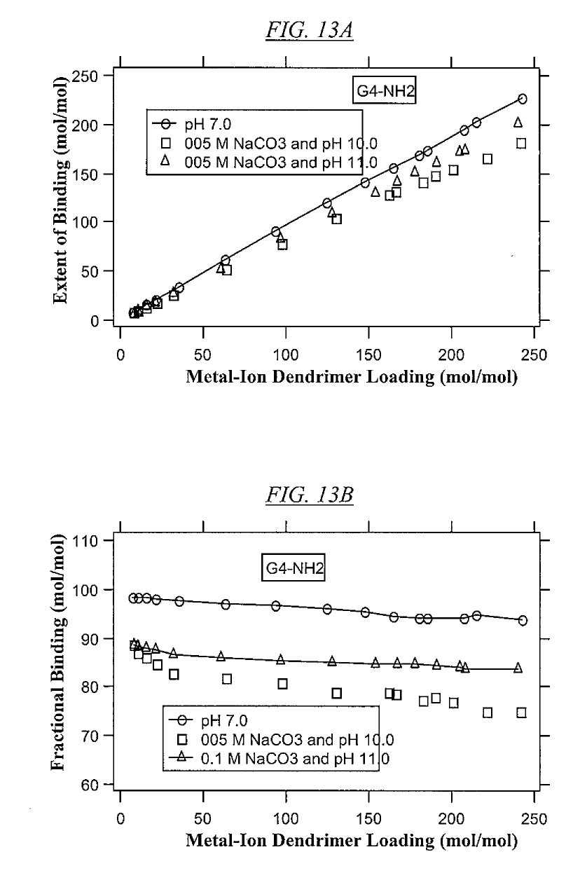

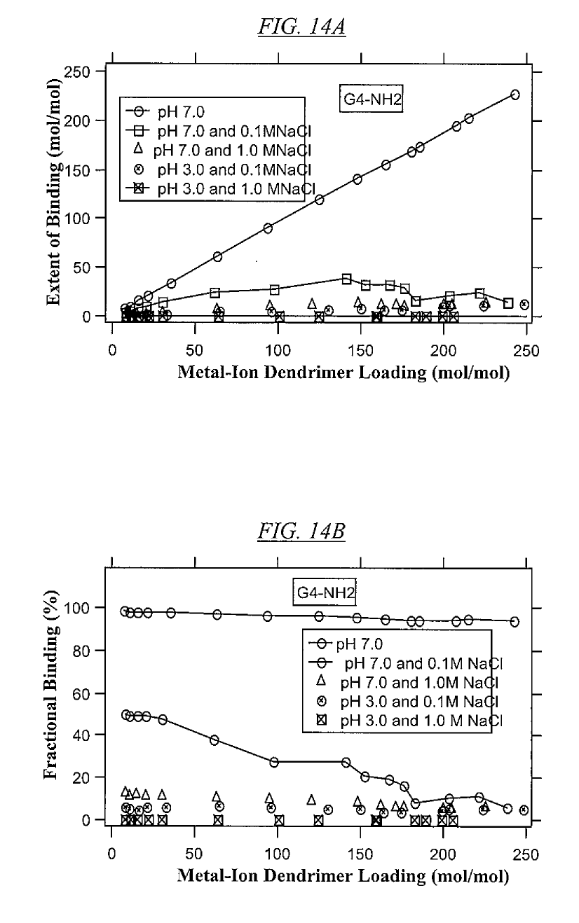

As is known in the art, the metal ion-binding properties of a dendritic macromolecule are not expected to change significantly based on large-scale rearrangements of its parts, such as cross-linking, extension, or the adding of branch cells. Dendritic macromolecules are examples of macroligands. Unlike small chelating agents such, macroligands have a very large number of metal ion coordination sites (e.g., N and O). In the case of dendritic macromolecules, the covalent attachment of these N and O metal ion coordination sites to dendritic branch cells enclosed within a “soft” and “open” water soluble nanoscale structure generates an enhanced ligand field with unusually large binding capacity for actinides such as U(VI) in aqueous solutions. Note that the actinide binding properties of dendritic macromolecules with N and O donors depend primarily on solution pH, background electrolyte concentration, density of N and O ligands (including bound water molecules), macromolecule branching pattern (including the placement of the O and N donors at points along that repeated pattern) and the flexibility of the macromolecule branch cells to coordinate with and bind actinide ions within the dendrimer interior and/or its exterior surface. This view is strongly supported by the linear relationship between the extent of binding of U(VI) and metal ion dendrimer loading observed in all aqueous solutions of PAMAM and PPI dendrimers that were tested in our supporting studies (see FIG. 7 through FIG. 14). Therefore, dendritic macromolecules that have roughly the same extent of branching, and roughly the same distribution and content of functional groups, and the same binding characteristics, are expected to be equivalent for purposes of the present disclosure.

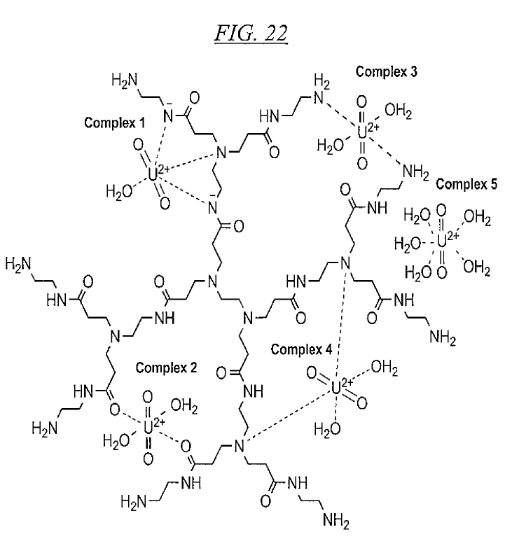

An illustrative description of the different U(VI) complexing “sites” of a PAMAM dendrimer is shown in FIG. 22. A broad range of experimental and computational techniques can be used to determine these complexing sites including x-ray absorption spectroscopy (e.g., EXAFS, XANES and NEXAFS), wide angle x-ray scattering (WAXS), relativistic density functional theory (DFT) calculations and molecular dynamics (MD) simulations, as is known in the art (e.g., Szabo et al. (2006)Coord. Chem. Rev. 250:784).

Dendritic macromolecules can be described as “soft” nanomaterials, with sizes in the range of 1 to 100 nm, can be used as high capacity and recyclable chelating agents for a variety of transition metal ions, lanthanides and actinides including Cu(II), Ni(II), Co(II), Pd(II), Pt(II), Zn(II), Fe(III), Co(III), Ag(I), Au(I), Gd(III) and U(VI). In particular, as shown in the present disclosure, dendritic macromolecules with N and O donors can serve as high capacity, selective and recyclable chelating agents for actinides such as U(VI), as well as radionuclides such as Th(IV), Am(III), Eu(III), Pu(IV) and Np(V).

Metal ion complexation is an acid-base reaction that depends on several parameters including (i) metal ion size and acidity, (ii) ligand basicity and molecular architecture and (iii) solution physical-chemical conditions. The Hard and Soft Acids and Bases (HSAB) principle provides “rules of thumb” for selecting an effective ligand (i.e., Lewis base) for a given metal ion (i.e., Lewis acid). According to the HSAB principle, “soft” metal ions such As(III) tend to form more stable complexes with “softer” ligands (i.e., those with S donors). Conversely, “hard” metal ions such Fe(III) tend to prefer “harder” ligands (i.e., those with O⁻ donors); whereas metal ions of “intermediate” softness/hardness such as Cu(II) can bind with soft/hard ligands depending on their specific affinity toward the ligands.

The coordination chemistry of actinides and lanthanides is to a large extent controlled by their “hardness” and the properties of their f-electrons. Actinides and lanthanides are “hard” Lewis acids and thus form strong complexes with “hard” Lewis bases including ligands with (i) O donors (e.g., sulfate, carbonate, phosphate, nitrate and organic ligands with carboxyl and carbonyl groups, as illustrative examples) and (ii) aliphatic/aromatic N donors. Because of “relativistic effects”, the 5f orbitals of the early actinides (thorium through plutonium) are larger and their electron are more weakly bound than those of lanthanides. Thus, these actinides exhibit a wide range of oxidation states (e.g., +2 through +7) and a greater tendency for their f-electrons to form covalent bonds, one example being the formation of actinyl MO₂²⁺ bonds by U(VI). These early actinides preferentially coordinate with ligands containing “hard” O and N donors. Thus, dendritic macromolecules with “hard” O and N groups provide ideal building blocks for developing high capacity, selective and recyclable chelating agents for these early actinides.

Trivalent actinides such as Am(III), on the other hand, tend to preferentially coordinate with ligands containing softer N donors (i.e., more polarizable and less electronegative than oxygen), such as triazoles and pyridine. Thus, dendritic macromolecules containing these heterocycle N groups provide ideal building blocks for developing high capacity, selective and recyclable chelating agents that will preferentially bind Am(III) over lanthanides such as Eu(III).

Ultrafiltration, combined with fluorescence spectroscopy, can be used to measure the extent of binding and fractional binding of U(VI) to PAMAM dendrimers with terminal NH₂, OH and COO⁻ groups, and to a PPI dendrimer with terminal NH₂ groups. Table 1 gives selected properties of some of the dendrimers discussed in this application.

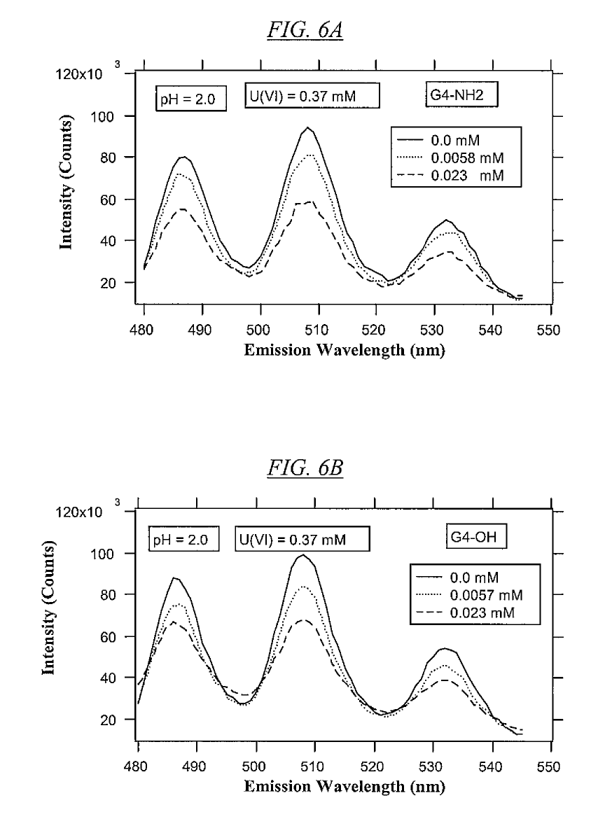

FIG. 6A and FIG. 6B illustrate fluorescence emission spectra of U(VI) in aqueous solutions of a G4-NH₂ and G4-OH PAMAM dendrimer, respectively, at room temperature and pH 2.0. Uranyl has a long-lived luminescent excited state that is very sensitive to its local environment. Methods for measuring fluorescence emission spectra are known in the art. Given these graphs, one of skill in the art will understand that the significant decrease of the fluorescence intensity of U(VI) in aqueous solutions plus dendrimer clearly shows that U(VI) binds to the PAMAM dendrimer.

Because PAMAM and PPI dendrimers are macroligands with a large number of N/O donors (Table 1), the conventional method used to study metal ion complexation by small ligands cannot satisfactorily be used to measure their U(VI) binding capacity. One method of quantifying cation and anion uptake by dendrimers in aqueous solutions is to measure the extent of binding (EOB) (the number of moles of bound ions per mole of dendrimer). The EOB of U(VI) is readily measured by (i) mixing and equilibrating aqueous solutions of uranyl and dendrimers, (ii) separating the uranyl-dendrimer complexes from the aqueous solutions by ultrafiltration and (iii) and measuring the uranyl concentrations of the equilibrated solutions and filtrates by fluorescence spectroscopy. The pH of dendrimer+cation/anion solutions can be controlled within 0.1-0.2 pH unit by addition of concentrated acid (e.g, HNO₃) or base (e.g., NaOH). When doing so, sufficient time must be allowed for the mixture to reach equilibrium, preferably about 30 minutes.

TABLE 1
Selected Physicochemical Properties of PAMAM and PPI

| Dendrimer | ^{a}M_{wth} | ^{b}N_{Terminal} | ^{c}N_{R3N} | ^{d}N_{amide} | ^{e}N_{H2Obound} | ^{f}N_{Ligand} |
|---|---|---|---|---|---|---|
| G5-NH₂ PAMAM | 28826 | 128 | 126 | 252 | 524 | 758 |
| G4-NH₂ PAMAM | 14215 | 64 | 62 | 124 | 201 | 374 |
| G3-NH₂ PAMAM | 6909 | 32 | 30 | 60 | ⁱNA | 182 |
| G4-OH PAMAM | 14279 | 64 | 62 | 124 | ⁱNA | 310 |
| G3.5 PAMAM | 12931 | 30 | 64 | 60 | ⁱNA | 214 |
| G5-NH₂ PPI | 7168 | 64 | 62 | 0 | ⁱNA | 126 |

^{a}M_{wth}: Theoretical molecular weight.
^{b}Nₜₑᵣₘᵢₙₐₗ: Number of terminal groups.
^{c}N_{R3N}: Number of tertiary amine groups.
^{d}N_{amide}: Number of amide groups. Note that each amide group has 2 electron donors: 1 N atom and 1 O atom.
^{e}N_{H2Obound}: Number of water molecules that are bound to the G4 and G5 PAMAM dendrimers at neutral pH (~7.0). The estimates are taken from Maiti et al. (23).
^{f}N_{Ligand}: number of dendrimer N and O ligands; N_{Ligand} = N_{Terminal} + N_{R3N} + 2N_{amide}. Note that the OH groups of the G4-OH PAMAM dendrimer do not appear to provide coordination sites for U(VI) ions (8).

It is possible to use the extent of binding (EOB) (i.e., the number of moles or grams of bound metal ions per mole or gram of dendritic molecule) to quantify cation/anion uptake by dendrimers in aqueous solutions. (If the dendritic molecule is very large or highly cross-linked, it is more convenient to discuss its mass, rather than the amount of its molecules.) Similarly, fractional binding is the fraction or percent of moles or grams of bound metal ions per moles or grams of metal ions loaded into the aqueous solution containing or surrounding the dendritic macromolecule.

FIG. 7A and FIG. 7B show the EOB and fractional binding (FB) of U(VI) in aqueous solutions of a G4-NH₂ PAMAM dendrimer as a function of metal ion-dendrimer loading and solution pH. Here, the concentration of U(VI) is constant at 10 ppm (ca. 3.7×10⁻⁵ M) and the molar ratio of uranyl to dendrimer NH₂ group [U(VI)/NH₂] varies from 0.125 to 3.8. At pH 9.0 and 7.0, 92-98% of the uranyl ions are bound to the dendrimer as shown in FIG. 7B. In this case, the G4-NH₂ PAMAM dendrimer can bind up to 220-227 uranyl ions without reaching saturation. On a mass basis, this is ca. 4200-4300 mg of U(VI) ions of per gram of dendrimer. The maximum uranyl binding capacity of poly(vinylamine) (PVA) (a linear polymer with NH₂ groups) is approximately 600 mg of U(VI) per gram of polymer. The uranyl binding capacity of typical IEX chelating resins with NH₂ groups is ca. 100 mg/g. The FB of U(VI is about 80% at pH 3.0 even though all the dendrimers N groups are protonated in this case. This unusually large U(VI) binding capacity of the G4-NH₂ PAMAM dendrimer FIG. 7A may be largely attributed to the high number of uranyl binding sites in the dendrimer. Table 1 shows that the G4-NH₂ PAMAM dendrimer has 64 primary amine (RNH₂) groups, 62 tertiary amine (R3N) groups and 124 amide (RCONH₂) groups. This corresponds to a total concentration of N and O donors of 5.70×0 10⁻⁵ M at pH 7.0 and metal ion-dendrimer loading of 242. The corresponding uranyl EOB and FB are, respectively, equal to 227 and 94%. The molar ratio of dendrimer N+O donors to UO₂²⁺ ions to is approximately 1.54 in this case. Note that water molecules bound to PAMAM dendrimers also provide non specific binding sites for metal ions.

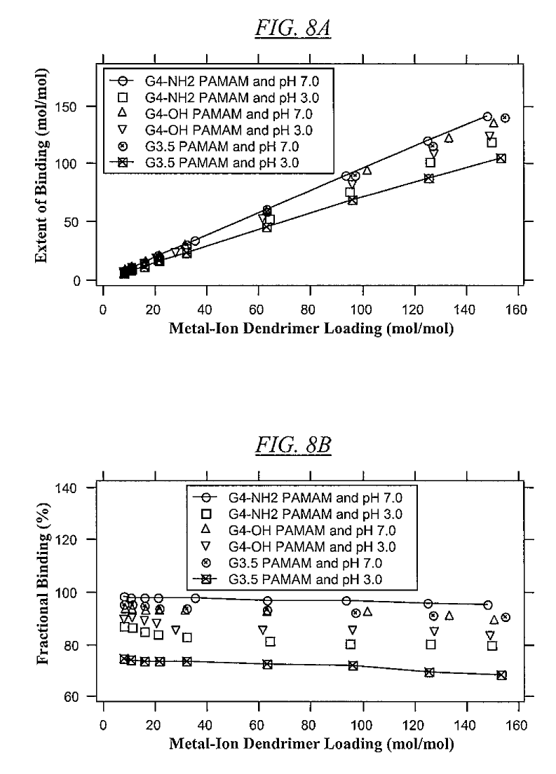

FIG. 8A illustrates the effects of dendrimer terminal group chemistry on the EOB of U(VI) in aqueous solutions of PAMAM dendrimers as a function of metal ion dendrimer loading and solution pH. In this case, the EOB and FB of U(VI) for PAMAM dendrimers with OH and COO⁻ terminal groups are comparable in magnitude to those of the G4-NH₂ PAMAM dendrimer at pH 7.0 and are slightly lower at pH 3.0.

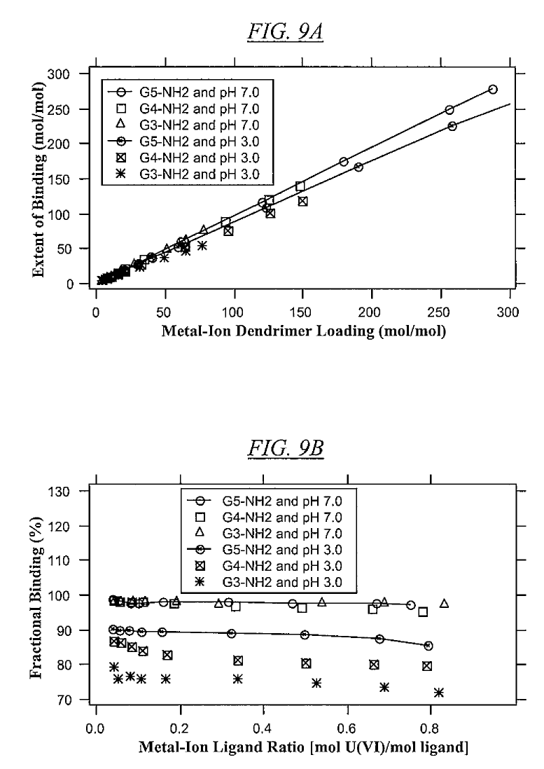

FIG. 9A and FIG. 9B show the effect of dendrimer generation on the EOB and FB of U(VI) to Gx-NH₂ PAMAM dendrimers. At pH 7.0, the EOB and FB of U(VI) of the PAMAM dendrimers are comparable. Conversely, the EOB and FB decrease with dendrimer (G5>G4>G3) at pH 3.0.

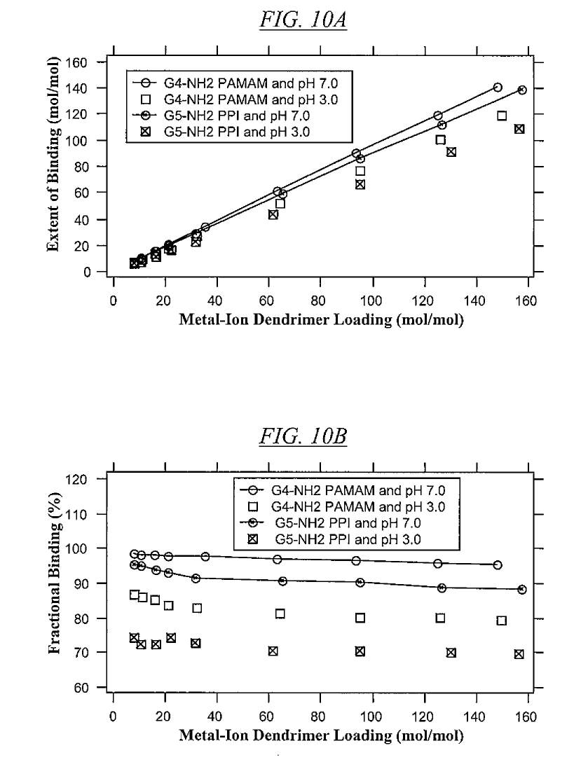

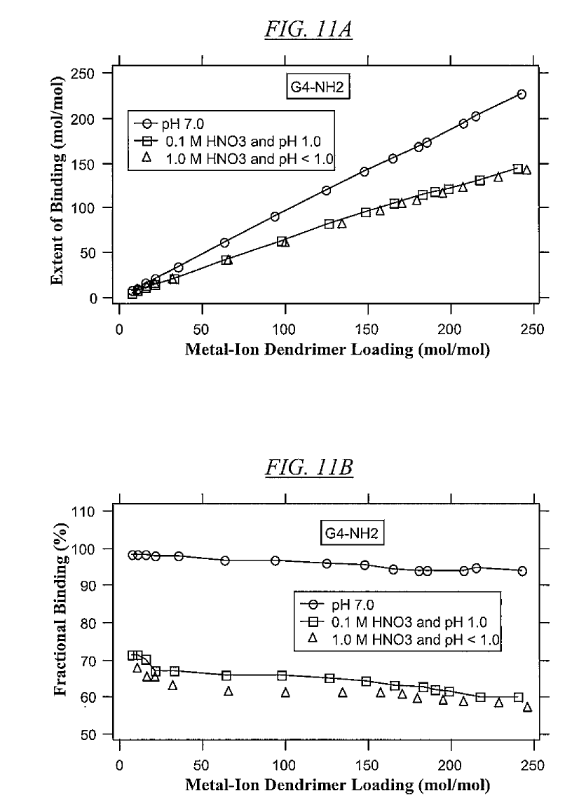

FIG. 10A and FIG. 10B show the binding of U(VI) to a G4-NH₂ PAMAM dendrimer and a G5-NH₂ PPI dendrimer. As shown in Table 1, both dendrimers have 62 tertiary amine (R₃N) and 64 primary amine (RNH₂) groups. However, the G5-NH₂ PPI dendrimer has no O or N amide donors; whereas the G4-NH₂ PAMAM dendrimer has 124 N/O amide donors. At pH 7.0 and molar ratio U(VI)/NH₂ of 2.4, the FB of uranyl to the PAMAM and PPI dendrimers are equal to 95% and 90%, respectively (data not shown). The corresponding EOB are about 140. Table 1 shows that the molar mass of the G5-NH₂ PPI dendrimer (7168 Dalton) is about half that of the G4-NH₂ PAMAM dendrimer (14215 Dalton). On a mass basis, this explains why the uranyl binding capacity of the G5 PPI dendrimer (about 4000 mg/g) is significantly larger than that of the G4 PAMAM dendrimer (˜2700 mg/g). The effects of ligands such nitrate and chloride on U(VI) binding to dendrimers are shown in FIG. 11A and FIG. 11B.

FIG. 11A shows significant binding of uranyl to the G4-NH₂ PAMAM dendrimer in acidic solutions containing up to 1.0 M HNO₃. In this case, the EOB of U(VI) is about 95 (1800 mg/g) with a FB of 61% (data not shown). Comparable EO and FB occur in acidic solutions containing up to 1.0 M H₃PO₄ and basic solutions (pH 11.0) containing up to 0.5 M Na₂CO₃. It is possible to suppress the uptake of U(VI) by the G4-NH₂ PAMAM in aqueous solutions containing at least 0.1 M (5.8 g/L) of sodium chloride at pH 3.0 (FIG. 11B).

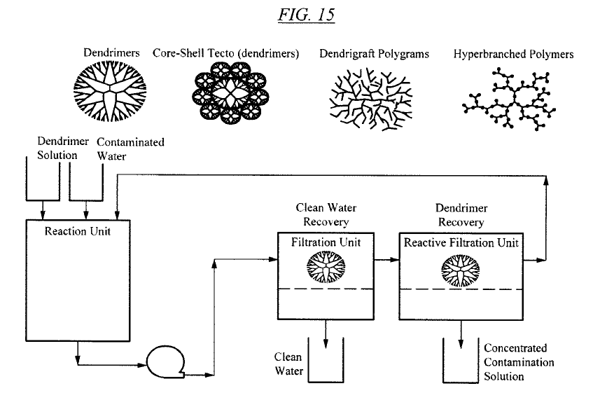

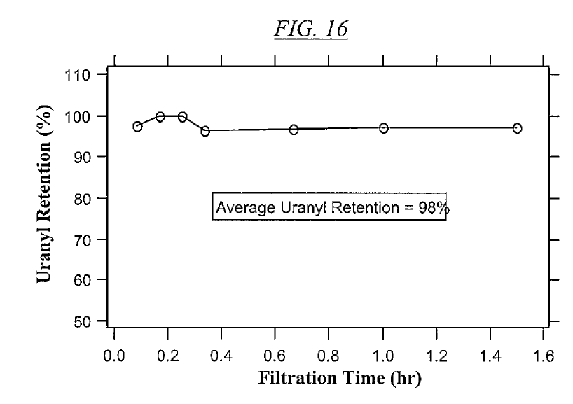

A cross-flow dendrimer ulfiltration (UF) can be carried out with aqueous solutions of U(VI) at pH 5.0 using a G4-NH₂ PAMAM dendrimer and a Sepa Cell, with a 5 KDalton polyethersulfone (PES) membrane in a configuration as shown in FIG. 15. Here, the cell inlet pressure can be set equal to 20 psi, and the concentration of U(VI) can be adjusted to 10 ppm (˜3.7×10⁻⁰⁵ M) with molar ratio U(VI)/NH₂=0.50. FIG. 16 shows a graph of the average retention of the dendrimer-uranyl complexes which may be obtained, which is approximately 98%.

Therefore, dendritic macromolecules with N and O donors such as PAMAM and PPI dendrimers, as well as PEI hyperbranched polymers, can serve as high capacity and recylable chelating ligands for actinides such as U(VI). The bound U(VI) ions can be released in acidic solutions, preferably the range pH 3.0 to pH 5.0, in the presence of small anionic ligands, at a molar concentration preferably greater than about 0.1 moles per liter, at approximately 6 g/L. Preferably, the small ionic ligand is Cl⁻, added in the form of NaCl; however, other small anionic ligands (e.g. acetate, oxalate, fluoride, etc.) with high binding affinity for U(VI) may be used to promote the release of bound U(VI) ions. One of skill in the art could easily identify other optimal combinations of pH and concentration of anionic ligands for releasing the bound U(VI) ions. Note that dendritic molecules similar to such PAMAM and PPI dendrimers or PEI hyperbranched polymers can also serve as high capacity and recyclable chelating agents for actinides such as U(VI), provided they are related to the above PAMAM and PPI dendrimers or PEI hyperbranched polymers in ways that are known in the art as not significantly altering the binding properties of the macromolecules.

As an illustrative example, one may perform a test to determine whether or not a particular dendritic macromolecule should be useful for the purpose of binding and releasing uranium or other actinides in a separation process. This test involves taking a quantity of pure water at room temperature, dissolving within it a quantity of the dendritic macromolecule, adding an acid such as HNO₃ sufficient to make the pH about 3, and then loading the solution with about 3 grams of U(VI) ions per gram of the dendritic macromolecule, taking care not to form precipitates. The fractional extent of binding should be greater than about 80%. The same procedure may then be repeated, except for the addition of at least 0.1 M NaCl prior to adding the U(VI) ions. The fractional extent of binding in this case, with the added NaCl, should be less than 20%. This is an illustrative example only, and dendritic macromolecules other than those that pass this test are also useful in practicing the present disclosure. For example, macromolecules that bind U(VI) ions in certain pH ranges, but release them at another pH range, may also be used.

One of skill in the art will understand which modifications can be made to the above PAMAM and PPI dendrimers, or to hyperbranched PEI polymers, or what alternate versions of related dendritic macromolecules will preserve the above functionality. However, many dendrimers are not ideally suited for the separation processes addressed by the present invention, due to issues of lability to acid, heat and radiation fields, molecular size, functionalization, or solubility. The present disclosure provides new families of highly branched macromolecules characterized by large size, functionalization with desirable ligands, and resistance to the reaction conditions used in actinide and radionuclide separation processes. One embodiment utilizes dendronized linear polymers, and a second embodiment uses core-crosslinked star polymers. Other embodiments employ chain-extended dendrimers and hyperbranched polymers. The complexing ligands may be varied, in ways known to those of skill in the art, to optimize binding capacity. Also, other polymer properties (e.g. size, shape, solubility, critical solution temperature, etc.) may be varied to facilitate recovery of the polymers after complexation.

The dendritic chelating agents of the present disclosure preferably exhibit resistance to a variety of pH conditions, and in some cases resistance to high radiation fields. Polystyrene can absorb 2000 electron volts of radiation per crosslink with no permanent damage, which is significantly more than other common polymers that might absorb only 20 to 30 electron volts without damage. Preferred embodiments employ a styrenic linear backbone consisting entirely of highly resistant C—C bonds, and dendritic branches based on stable amide chemistry. For example, a polystyrene backbone with pendant lysine-based amide branching units may be obtained by divergent growth of lysine moieties from groups pendant on the polymer main-chain. The polylysine branches are known to be resistant to acid, and provide long-term stability desirable for separation media. While the amide residues of the branched lysine arms contribute to actinide complexation, preferred embodiments derive additional complexation by terminating the dendrimer branches with polyamine units.

### EXAMPLE I

### Functionalized Hyperbranched Polyethyleimine Polymers

Hyperbranched polyethyleneimine (PEI) is a spherical dendritic macromolecule defined by a branch content of approximately 65-70%, containing tertiary, secondary, and primary amines. Various molecular weights ranging from about 1,000 to several million Daltons are known and found to be infinitely soluble in water. The high amine contents and branched structures, render these macromolecules attractive for complexing U(VI). A further strength of hyperbranched PEI for use in the present disclosure is the ease of chemical functionalization, which can allow the incorporation of functional groups, which will enhance the binding capacity of the macromolecule (e.g. amido groups among many others). PEI may also be modified for use in the present disclosure by cross-linking.

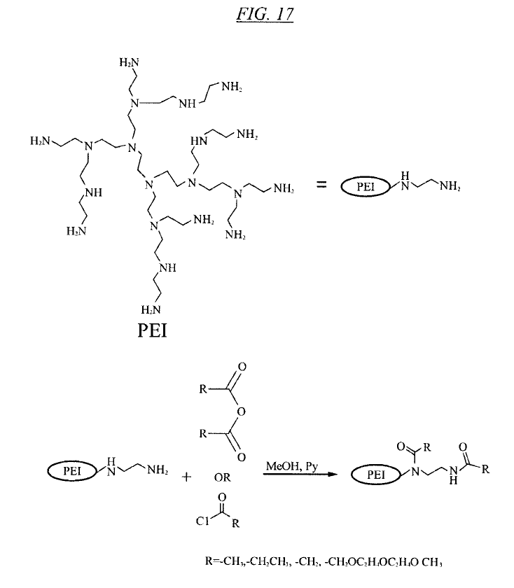

FIG. 17 illustrates several example chemical modification strategies for PEI based on the conversion of amines to amido functional groups via reaction of the macromolecule with anhydrides or acid chlorides. Preferably, this reaction should take place in the presence of methanol and pyridine. The other conditions and procedures for this reaction will be known to one of skill in the art.

The R group can be varied so as to fine tune the properties of the macromolecule in relation to binding capacity, macromolecule-ore interactions, and solubility. Three specific examples are shown. In all cases, conversion of primary and secondary amine functional groups to amide groups results in the incorporation of carbonyl groups, which have been shown to have particularly attractive binding properties for U(VI), and can thus dramatically enhance the biding capacity of the macromolecule. In the specific case of acetamides (R=methyl) or amides with longer alkyl chains, conversion of amines to the alkyl functionalized amides is intended to reduce sorption of the macromolecule to gangue minerals in the solution mining process. Also, if necessary, a certain percentage of amides can incorporate oligoethylene oxide solubilizing groups can be used to enhance the water solubility of the modified-PEIs.

### EXAMPLE II

### Polystyrene-Cored Dendronized Polymers

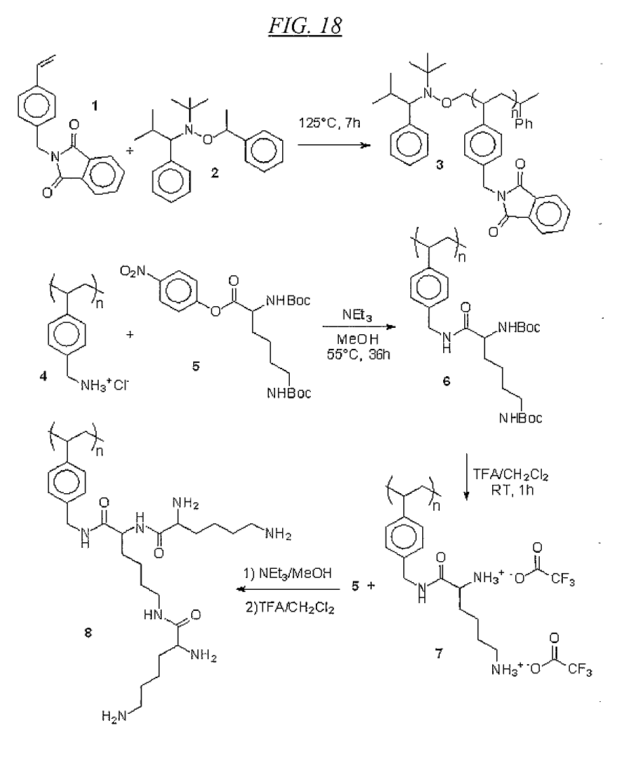

An example of the preparation of a polystyrene-cored dendronized polylysine is shown in FIG. 18. A poly(4-aminomethylstyrene) backbone polymer 4 with controlled chain length and low polydispersity is obtained by polymerization of monomer 1 with alkoxyamine initiator 2 to afford protected polymer 3 that can be deprotected to 4. The subsequent dendronization steps may be carried out using lysine derivative 5, which contains an excellent leaving group to ensure that functionalization is achieved in essentially quantitative yield. Structure 8 in FIG. 18 already contains 3 amido and 4 primary amine groups per styrene repeat unit. Carrying out the dendronization one step further would increase these functionalities to 7 amido and 8 amino groups. Another round of dendronization provides 15 amido and 16 amino groups per dendrimer side chain. The entire dendronized polymer chain thus possesses enormous complexing capacity.

A variety of embodiments, having analogous multivalent complexing structures, may be synthesized by employing a variety of complexing building blocks, as is known in the art. Suitable examples include, but are not limited to, dendronized polymers having molecular weights between 500,000 and 5,000,000 and bearing one to five generations of dendrimer branches. Suitable complexing groups include, but are not limited to, amino, ester, amide, and ether functionalities. Preferred embodiments are those with three to five generations of branching, and with amino groups comprising at least a portion of the complexing groups.

Chelating agents containing heterocyclic N groups such as triazoles are expected to preferentially bind Am(III) over lanthanides such as Eu(III), and dendronized triazole polymers with a polystyrene backbone are preferred embodiments where Am(III) binding is desired. Among other possibilities, one route of synthesis known in the art, called “click-chemistry,” which exploits the Cu(I) synthesis of 1,2,3-triazoles from azides and alkynes (Wu et al. (2004), Angew. Chem. Int. Ed. 43:3928), may be used to synthesize triazole dendrimers, for purposes of practicing the inventions disclosed herein. This is a very simple reaction that can be carried out at nearly quantitative yields in aqueous solutions without protection from oxygen. It requires little more than mixing and stirring stoichiometric amounts of the reactants and catalysts, and is suitable for preparing the dendritic chelating agents of the present invention.

Numerous chain-ends can be introduced onto all of the dendritic structures mentioned herein, and a library approach involving a limited number of dendronized polymers and a multiplicity of complexing end-groups enables the synthesis of a variety of group and chain-end combinations, which makes possible the selection of agents having the most suitable combination of complexing capacity and recovery properties for a given application.

### EXAMPLE III

### Core Crosslinked Star Polymers

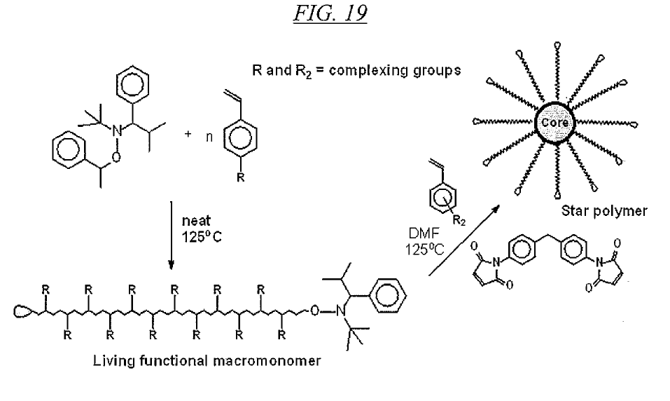

Core crosslinked star polymers are a new family of highly functionalized, highly branched macromolecules, synthesized using high throughput experimentation techniques that are known in the art. The term core crosslinked star polymer is, as used in this disclosure, has its normal meaning as known in the art. Despite their name, these polymers are not insoluble, due to the intrinsic solubility of their arms and the small size of their cores. These polymers can be obtained by the reaction of pre-formed living macromonomers with a crosslinker molecule diluted with a functional (in this case complexing) monomer as shown in FIG. 19. The living macromonomers form the multiple branches of the final star, while the crosslinker and functional monomer form the bulk of the core.

Depending on the conditions used, stars with hundreds of arms and molecular weights reaching in the millions can be obtained. Since the macromonomer arms themselves can contain complexing functionalities, the resulting structures may have a desirable multivalent character, with hundreds or thousands of complexing groups per molecule, as well as a size useful for their application as complexing media for actinides. A particular advantage of the method is that all connecting bonds in the core and the arms can be carbon-carbon bonds, thus ensuring stability even to highly concentrated acid.

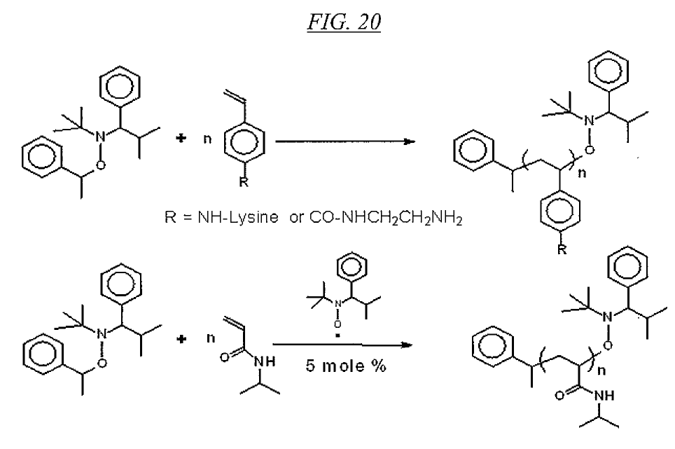

Two examples of living macromonomers with complexing functionalities are shown in FIG. 20. The first macromonomer is styrene-based, with pendant groups containing both amide and primary amine ligands, derived from lysine and ethylene diamine. As with the dendronized linear polymers, a library approach may be used to select the ligands with the best complexing properties for a given application. Such ligands may be introduced either at the starting monomer stage, by chemical modification of the macromonomer, or by modification of the star itself. The second macromonomer of FIG. 20 is based on substituted acrylamide monomers, which are known for their excellent complexing properties. Once again a variety of ligands can be used, and a library approach may be employed to optimize binding capacity and/or selectivity. Many polymers of functional acrylamides have a low critical solution temperature that enables them to be thermally responsive, and in certain embodiments of the invention the actinide recovery process will involve temperature-induced precipitation after complexation.

### EXAMPLE IV

### Chain Extended Dendrimers and Hyperbranched Polymers

The size of dendrimers and many hyperbranched polymers is such that recovery generally requires the use of ultrafiltration or other equivalent methods that are known in the art. Certain embodiments of the present invention feature the enlargement of these dendritic macromolecules in order to facilitate recovery using microfiltration membranes with very large pores. For example, poly(propylene imine) or poly(lysine) dendrimers, both of which can be obtained from simple starting materials, may be extended by using their chain ends to initiate a living polymerization of monomers such as those shown in FIG. 20, or dendronized analogs based for example on lysine side-chains. Alternatively, hyperbranched structures may be used as starting materials, and dendronized further with multiple complexing groups using click chemistry as is known in the art. Once again a great variety of structures can be prepared through the use of a library approach.

### EXAMPLE V

### Separations of Actinides from Aqueous Solutions by Dendrimer Filtration

The present disclosure provides methods for separating actinides and lanthanides from aqueous solution using actinide- and lanthanide-specific dendrimers. Numerous methods known in the prior art may be adapted for use with the dendrimers of the present disclosure, solvent extraction as in the PUREX process, extraction in novel fluid media (e.g., supercritical fluids and room-temperature ionic liquids), magnetic separation, or preferably the process of dendrimer filtration (DF) (FIG. 15) disclosed in M. Diallo, U.S. patent application publication No. 20060021938. The dendrimer filtration (DEF) process combines water soluble dendritic macromolecules (with very high binding capacity and selectivity for U(VI) such as those disclosed in this application) with the well establish membrane-based separation technologies such ultrafiltration (UF) and microfiltration (MF). Because of this unique feature, DEF will enable the recovery and concentration (approximately 100-1000 fold) of uranium from ISR leach solutions. Note that the bound U(VI) can be stripped from the concentrated U(VI) dendrimer solutions by addition of small amounts salts (preferably, about 6 g/L of NaCl compared to at least 30 g/L for IEX resins) at pH 3-5. This also enables the recovery and recycling of the dendritic macromolecules.

Key advantages of the use of dendrimer filtration (DF) in ISR uranium mining include:
1. Significant reduction in the amount of processing fluids. No need to transport large amount of U(VI) loaded resins to processing facilities. This could mean significant costs savings and reduced environmental impact.
2. Seamless integration with commercially available membrane systems. No novel equipment is needed to implement this technology. For the most part, only accessories such as pumps, pipes and reaction vessels [to mix the dendrimers with the leaching solutions] will be needed.
3. Flexible, mobile and scalable process. Because DEF is a membrane-based process, it is a mobile and fully scalable process.
   Thus, DEF could be used to develop small mobile membrane systems that can be moved around a ISR field as well as larger and fixed treatment systems.

Indeed, DEF could also be used as pre-treatment or post-treatment or alternative to reverse osmosis (RO) to treat contaminated groundwater during the decommissioning of ISL uranium mines. Note that in this case, the system equipment used to recover and concentrate U(VI) ions from the leaching solutions could also be used in the groundwater restoration phase of an ISR mine. This could result in significant savings of capital costs and operating costs.

In another embodiment, cross-flow dendrimer ulfiltration (UF) can be carried out with aqueous solutions of U(VI) at pH 5.0 using a G4-NH₂ PAMAM dendrimer and a Sepa Cell, with a 5 KDalton polyethersulfone (PES) membrane in a configuration as shown in FIG. 15. Here, the cell inlet pressure can be set equal to 20 psi, and the concentration of U(VI) can be adjusted to 10 ppm (˜3.7×10⁻⁰⁵ M) with molar ratio U(VI)/NH₂=0.50.

In a further embodiment, the present disclosure provides for the use of dendrimer filtration to recover actinides or other radionuclides from complex aqueous solutions. For example, U(VI) and Th(IV) may be recovered from complex aqueous solutions of interest to spent nuclear fuel processing. U(VI) and Th(IV) complexes with dendritic macromolecules may be retained, for example, using commercially available ceramic membranes such as zircona Membralox™ membranes from the Pall Corporation having relatively large pore sizes (>20 nm). Hydrolytically stable and radiation-resistant dendritic macromolecules and ceramic membranes are ideal for applications that involve extreme conditions such as high temperature/pressure and high acid media, and are generally preferred for use in the present invention.

### EXAMPLE VI

### Separations of Actinides from Solutions Using Solid Supported Dendritic Macromolecular Systems

An alternative type of filter is one in which the filtering entity is in contact with a solid support or matrix. In this case, the actinide-selective dendritic macromolecules disclosed in this patent application may be attached to or non covalently deposited on a surface of a porous or nonporous solid matrix. A number published articles describe the sorption of PAMAM dendrimers onto porous and nonporous solids including silica, activated alumina and zeolite, and may be used by those of skill in the art to practice the present disclosure (e.g., Ottaviani (2003), J. Phys. Chem. B, 107:2046) and Esumi (1998), Langmuir, 14:4466). There are also many ways known in the art for covalently attaching PAMAM and PPI dendrimers to silica coated iron magnetic nanoparticles (e.g., Grüttner et al. (2005), J. Magnetism. Magnetic. Mat., 293:559 and Reziq (2006), J. Amer. Chem. Soc., 128:5279).

Thus, one of skill in the art could easily covalently or non-covalently attach the dendritic macromolecules disclosed in this application to solid supports on interest to water purification including alumina and silica nano and microparticles. Note that low-cost materials such Ottawa Sand could be non-covalently coated with these dendritic macromolecules to make low-cost filters. In one embodiment of the present inventions, aqueous solutions containing actinides (e.g. uranium) are contacted with dendrimer-coated silica, alumina or zeolite particles. Water from which at least a portion of the contaminants have been removed is produced. For the specific case of U(VI), these filters could be regenerated by releasing the bound U(VI) ions using a washing solution of preferably 6.0 g/L of sodium chloride at a pH preferably at about 5.0 as described in Example V. Here again, of skill in the art one of skill in the art could easily identify other optimal combinations of pH and concentration of anionic ligands (e.g., acetate and oxalate) for releasing the bound U(VI) ions.

### EXAMPLE VII

### Dendrimer Enhanced ISL Uranium Mining and Heap Mining

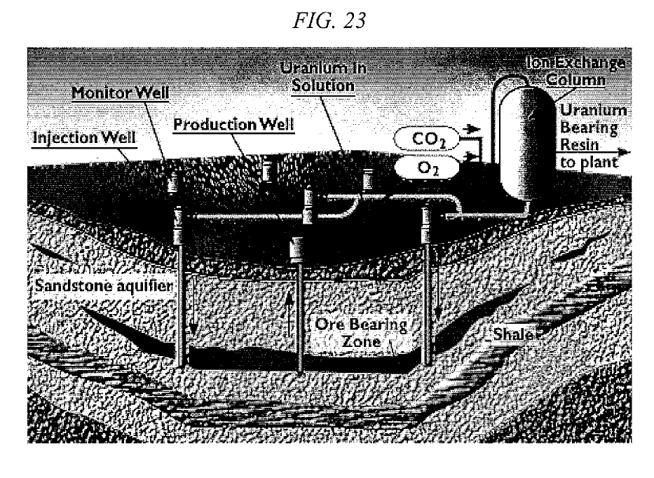

The dendritic macromolecules disclosed in this invention can be used in the process of in situ leach mining, as shown in FIG. 23. In one embodiment, uranium-laden lixiviant exiting the ore deposit is contacted with a uranium selective dendrimer, and then ultrafiltered or microfiltered, as appropriate to the size of the dendrimer, to separate the metal carrying dendrimer from the bulk of the liquid. The resulting concentrated solution of metal-carrying dendrimer is then contacted with a stripping solution, such as for example an acid, alkali, or salt solution, which is capable of displacing the metal or oxo-metal ion from the dendrimer.

Suitable apparatus for the above processes are well-known in the fields of water purification and chemical process engineering.

In another embodiment, the dendritic macromolecules are dissolved in the lixiviant prior to being pumped into the ore deposit, and the dendrimer carries the metal or oxo-metal ions to the surface where it is processed as above. As previously, the formulation of the lixiviant solution is an important step for uranium ISL mining. It determines to a large extent the feasibility, cost, environmental impact and public/regulatory acceptance of ISL mining. The dendritic macromolecules disclosed in this invention can be used for a more efficient and environmental acceptable lixiviant formulations. In one embodiment of the present invention, a low-cost and uranium-selective dendritic macromolecule with low sorption affinity for gangue minerals present in uranium mines can be prepared by functionalizing the terminal or interior groups of a hyperbranched PEI polymer with acetamide or polyethylene oxide. Thus, a lixiviant solution (pH preferably in the range of 5 to 8) consisting of the functionalized PEI hyperbranched polymer+O₂ can be easily prepared and used as low cost and environmental acceptable alternative to existing acid and alkaline lixiviant.

In another embodiment, the dissolution of the metal and other reactions take place on the surface, with ore that has already been mined and collected for surface-processing. This is called heap mining and/or dump leaching. The same processes and methods used for in situ leach mining may also be used for heap mining, although there is no need to pump lixiviant to and from an underground location.

While embodiments and applications have been shown and described, it would be apparent to those skilled in the art having the benefit of this disclosure that many more modifications than mentioned above are possible without departing from the inventive concepts disclosed herein. The invention, therefore, and the scope of the appended claims, should not be limited to the embodiments described herein.

What is claimed is:

1. A dendritic macromolecule comprising:
a core;
a plurality of arms extending from the core, the arms having a hyperbranched structure;
within the hyperbranched structure, a plurality of units satisfying the following formula: 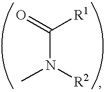
wherein R¹ is a first group and R² is a second group which may or may not be the same as the first group; and
wherein R¹ comprises no nitrogen atoms in which the nitrogen atom is directly bound to two or more carbon atoms.

2. The dendritic macromolecule of claim 1, wherein R¹ is an alkyl group.

3. The dendritic macromolecule of claim 2, wherein R¹ is a methyl group.

4. The dendritic macromolecule of claim 2, wherein R² comprises an oligoethyline oxide group.

5. The dendritic macromolecule of claim 2, wherein R² comprises a hyperbranched structure.

6. The dendritic macromolecule of claim 3, wherein R² is hydrogen.

7. The dendritic macromolecule of claim 1, wherein R¹ is a solubilizing group.

8. The dendritic macromolecule of claim 7, wherein R¹ is a polyethylene oxide group.

9. The dendritic macromolecule of claim 1, wherein, after a quantity of the dendrimer is made to absorb a quantity of radiation from a ⁶⁰Co source corresponding to 100 electron volts per crosslink, the maximum loading of U(VI) within the exposed dendritic macromolecule will decrease by no more than 10%.

10. The dendritic macromolecule of claim 9, wherein the dendritic macromolecule is a dendronized polymer comprising a polylysine backbone.

11. The dendritic macromolecule of claim 1, wherein, when the dendritic macromolecule is dissolved in a first quantity of pure water at room temperature, sufficient HNO₃ is added to make the pH about 3, and the solution is loaded with about 3 grams of U(VI) ions per gram of the dendritic macromolecule, the fractional extent of binding is greater than about 80%; and wherein, when the dendritic macromolecule is dissolved in a second quantity of pure water at room temperature, sufficient HNO₃ is added to make the pH about 3, sufficient sodium chloride is added to produce an aqueous solution containing at least 0.1 Molar sodium chloride, and the solution is loaded with about 3 grams of U(VI) ions per gram of the dendritic macromolecule, the fractional extent of binding is less than about 20%.

12. The dendritic macromolecule of claim 1, wherein the dendritic macromolecule is a core crosslinked star polymer comprising a central core of crosslinked di(alkenyl) aromatic hydrocarbon and a plurality of functionalized branches.

13. A method of preparing a dendritic macromolecule comprising the steps of:
mixing a hyperbranched polyethyleneimine (PEI) molecule with an agent selected from the group consisting of an anhydride and an acid chloride;
providing conditions wherein the PEI will react with the agent to produce the dendritic macromolecule of claim 1.

14. The method of claim 13, wherein the agent is an anhydride.

15. The method of claim 13, wherein the agent is an acid chloride.

16. A separation method comprising the steps of:
introducing the dendritic macromolecule of claim 1 which is bound to a metal element selected from the actinide family of chemical elements into an aqueous environment at a pH level that is less than about 5, wherein the concentration of an ionic salt in the aqueous environment is about 0.1 moles per liter of solution, to produce a first composition of matter comprising an unbound dendritic macromolecule and an unbound metal element;
extracting the unbound dendritic macromolecule from the aqueous solution.

17. The method of claim 16, wherein the pH level is less than about 3.

18. A method for in-situ leach mining comprising the steps of:
(A) contacting an ore with a lixiviant solution, wherein metal ions originating in the ore are dissolved in the lixiviant solution to create a first product composition comprising dissolved metal ions;
(B) providing conditions whereby the dissolved metal ions bind to a dendritic macromolecule to form a second product composition comprising an ion-macromolecule complex; and
(C) extracting the ion-macromolecule complex from the second product composition, thus creating a third product composition that is relatively rich in the ion-macromolecule complex, and a fourth product composition that is relatively poor in the ion-macromolecule complex, wherein the weight fraction of total ion-macromolecule complex in the fourth product composition is less than 5% or is zero.

19. The method of claim 18, wherein:
in step (A), the contact between the ore and the lixiviant solution takes place within a first reaction zone but does not measurably take place within a second reaction zone;
in step (B), the binding reaction between the metal ions and the dendritic macromolecule takes place within the second reaction zone but does not measurably take place within the first reaction zone;
step (B) further comprises mixing a dendritic agent with a solution comprising the first product composition, the dendritic agent comprising the dendritic macromolecule; and
the method further comprises the step of extracting the dendritic macromolecule from the fourth product composition.

20. The method of claim 19, wherein the dendritic macromolecule is physically or covalently bound to a solid support.

21. The method of claim 20, wherein the solid support is a microparticle or nanoparticle selected from the group consisting of alumina and silica.

22. The method of claim 19 wherein the ore is situated within the ground in its natural state, further comprising the step of:
creating a channel or fissure within the ground wherein is provided a route for fluid communication between a reservoir of the lixiviant solution and the ore.

23. The method of claim 20, wherein the metal ions comprise uranium (VI):

24. The method of claim 23, wherein the dendritic macromolecule comprises the composition of claim 1.

25. The method of claim 18, wherein:
the lixiviant solution comprises the dendritic macromolecule;
the contact between the ore and the lixiviant solution in step (A) and the binding reaction between the metal ions and the dendritic macromolecule in step (B) take place within the same reaction zone; and
the method further comprises the steps of:
(D) providing conditions within the third product composition wherein the ion-macromolecule complex dissociates to form a fifth product composition comprising the metal ions and the dendritic macromolecule;
(E) extracting the dendritic macromolecule from the fifth product composition.

26. The method of claim 25 wherein:
the ore is situated within the ground in its natural state;
the step (D) of providing conditions comprises adding an ionic salt and decreasing the pH to less than about 5; and
wherein the lixiviant solution further comprises O₂.

27. The method of claim 26, wherein the method further comprises the step of creating a channel or fissure within the ground wherein is provided a route for fluid communication between a reservoir of the lixiviant solution and the ore.

28. The method of claim 25, wherein the metal ions comprise uranium (VI).

29. The method of claim 28, wherein the dendritic macromolecule comprises the composition of claim 1.

30. A facility for in-situ leach mining comprising:
dissolving means within an underground channel situated adjacent to a mass of underground ore for contacting the ore with a lixiviant solution, wherein metal ions originating in the ore are dissolved in the lixiviant solution to create a first product composition comprising dissolved metal ions;
binding means for allowing the dissolved metal ions to bind with a dendritic macromolecule to form a second product composition comprising an ion-macromolecule complex; and
a first separation unit comprising means for extracting the ion-macromolecule complex from the second product composition, thus creating a third product composition that is relatively rich in the ion-macromolecule complex, and a fourth product composition that is relatively poor in the ion-macromolecule complex, wherein the weight fraction of total ion-macromolecule complex in the fourth product composition is less than 5% or is zero.

31. The facility of claim 30, further comprising:
a first reservoir on or near the earth's surface suitable for holding the lixiviant solution;
a first channel or fissure within the ground, situated such that there is provided a route for fluid communication between the first reservoir and the ore;
a second reservoir on or near the earth's surface suitable for holding the first product composition;
a second channel or fissure within the ground, situated such that there is provided a route for fluid communication between the ore and the second reservoir;
means for mixing the lixiviant with the first product composition; and
means for extracting the dendritic macromolecule from the fourth product composition.

32. The facility of claim 31, wherein the metal ions comprise uranium (VI).

33. The facility of claim 31, wherein the means for extracting the dendritic molecule from the fourth product composition comprises means for adding an ionic salt and decreasing the pH to less than about 5.

34. The facility of claim 32, wherein the dendritic macromolecule comprises the composition of claim 1.

35. The facility of claim 30, further comprising:
means for mixing the lixiviant with the dendritic macromolecule to produce a fifth product composition;
a first reservoir on or near the earth's surface suitable for holding the fifth product composition;
a first channel or fissure within the ground, situated such that there is provided a route for fluid communication between the first reservoir and the ore;
a second reservoir on or near the earth's surface suitable for holding the second product composition;
a second channel or fissure within the ground, situated such that there is provided a route for fluid communication between the ore and the second reservoir; and
means for extracting the dendritic macromolecule from the fourth product composition.

36. The facility of claim 35, wherein the metal ions comprise uranium (IV).

37. The facility of claim 36, wherein the dendritic macromolecule comprises the composition of claim 1.
